(19) United States
(12) Patent Application Publication
(10) Pub. No.: US 2006/0164985 A1
(43) Pub. Date: Jul. 27, 2006

(54) Apparatus and method for enhanced flow control in a wireless network

(75) Inventor: William J. Semper, Richardson, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/205,946

(22) Filed: Aug. 17, 2005

Related U.S. Application Data
(60) Provisional application No. 60/647,742, filed on Jan. 27, 2005.

(51) Int. Cl. H04L 12/26; H04Q 7/00; H04L 12/56

(52) U.S. Cl. 370/230; 370/328; 370/412

(57) ABSTRACT

An apparatus and a related method for controlling the flow of data packets to a base station of wireless network, including a flow control mechanism between the transmission buffer located in the base station and the packet data buffer, which may be located in the radio access network (e.g., in the PCF) or in the packet data network (e.g., in the PDSN), or in another similar source device.

### CROSS-REFERENCE TO RELATED APPLICATION AND CLAIM OF PRIORITY

The present application is related to that disclosed in U.S. Provisional Patent No. 60/647,742, filed Jan. 27, 2005, entitled “Apparatus and Method for Enhanced Flow Control in a Wireless Network”. U.S. Provisional Patent No. 60/647,742 is assigned to the assignee of the present application. The subject matter disclosed in U.S. Provisional Patent No. 60/647,742 is hereby incorporated by reference into the present disclosure as if fully set forth herein. The present application hereby claims priority under 35 U.S.C. §119(e) to U.S. Provisional Patent No. 60/647,742.

### TECHNICAL FIELD OF THE INVENTION

The present application relates generally to wireless networks and, more specifically, to a mechanism for controlling the flow of data from a packet data network to a base station in a CDMA2000 wireless network.

### BACKGROUND OF THE INVENTION

Businesses and consumers use a wide variety of fixed and mobile wireless terminals, including cell phones, pagers, Personal Communication Services (PCS) systems, and fixed wireless access devices (i.e., vending machine with cellular capability). Wireless service providers continually try to create new markets for wireless devices and expand existing markets by making wireless devices and services cheaper and more reliable. To attract new customers, wireless service providers implement new services, especially digital data services that, for example, enable a user to browse the Internet or send and receive e-mail.

Data for these new services is typically transmitted as packet data between the base stations of the wireless network and the mobile stations accessing the wireless network. Packet data services frequently require some type of flow control mechanism that regulates the transmission of data packets from a source buffer to a destination buffer in order to avoid overflow or underflow conditions.

However, conventional wireless networks exhibit poor packet data flow control. A typical prior art wireless network only provides explicit ON/OFF signaling between the transmission buffer (TXBUFF) in the base station and the packet data buffer (PDB) located in, for example, a packet data serving node (PDSN) or a packet control function (PCF) unit associated with the wireless network. The explicit ON/OFF signaling occurs in explicit messages over the A8 interface or the A10 interfaces. This is an inefficient method for flow control. The delay time required to process the ON/OFF signals results in lost transmission time over the air. It is difficult to attain good buffer synchronization using the simple ON/OFF signaling mechanism.

Therefore, there is a need in the art for a more efficient flow control mechanism between the base station and the PCF or PDSN.

### SUMMARY OF THE INVENTION

A preferred embodiment provides a method of controlling the flow of data packets from a packet data buffer in a source device to a transmission buffer in a base station. According to an advantageous embodiment of the present disclosure, the method comprises receiving a data frame including a GRE protocol header from the base station in the source device, wherein the GRE protocol header comprises a buffer level field indicating the level of data packets in the transmission buffer; and regulating the flow of data packets from the packet data buffer in the source device to the transmission buffer based on the level of data packets indicated in the buffer level field.

Another embodiment provides a source device, comprising a packet data buffer; a receiver component configured to receive a data frame including a Generic Route Encapsulation protocol header from a base station, wherein the Generic Route Encapsulation protocol header comprises a buffer level field indicating the level of data packets in a transmission buffer of the base station; and a transmission component configured to send a regulated flow of data packets from the packet data buffer to the base station based on the level of data packets indicated in the buffer level field.

Another embodiment provides a base station, comprising a transmission buffer containing packet data; a controller configured to transmit a data frame including a Generic Route Encapsulation protocol header to a source device, wherein the Generic Route Encapsulation protocol header comprises a buffer level field indicating a level of data packets in the transmission buffer.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that implements enhanced packet flow control according to the principles of a preferred embodiment of the present disclosure;

FIG. 2 illustrates selected portions of the wireless network in greater detail according to an exemplary embodiment of the present disclosure;

FIG. 3 illustrates selected portions of the wireless network in greater detail according to an alternate embodiment of the present disclosure;

FIG. 4 illustrates a Generic Route Encapsulation (GRE) protocol header according to an exemplary embodiment of the present disclosure; and

FIGS. 5A and 5B depict flowcharts of processes according to the principles of the present disclosure.

### DETAILED DESCRIPTION OF THE INVENTION

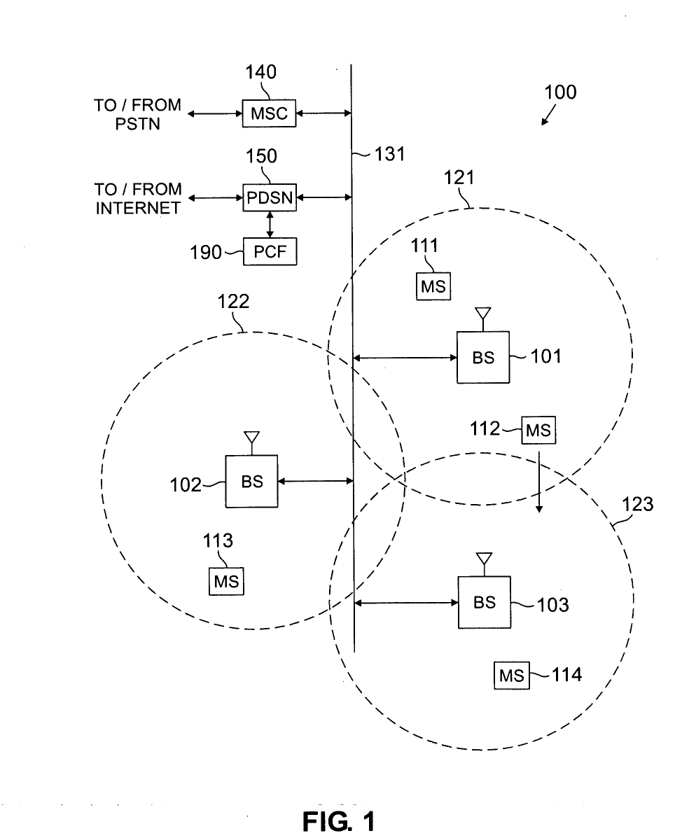

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

A preferred embodiment provides an apparatus and a related method for controlling the flow of data packets from a packet data network to a base station of a CDMA2000 radio access network. This is accomplished by a more efficient flow control mechanism that manages the signaling between the base station and the PCF or the PDSN. A preferred embodiment implements a detailed flow control mechanism between the transmission buffer located in the base station and the packet data buffer, which can be located in the radio access network (e.g., in the PCF) or in the packet data network (e.g., in the PDSN), or in another similar source device.

FIG. 1 illustrates exemplary wireless network 100, which implements enhanced packet flow control according to the principles of a preferred embodiment of the present disclosure.

Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present disclosure, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present disclosure is not limited to mobile devices. The present disclosure also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell site configuration.

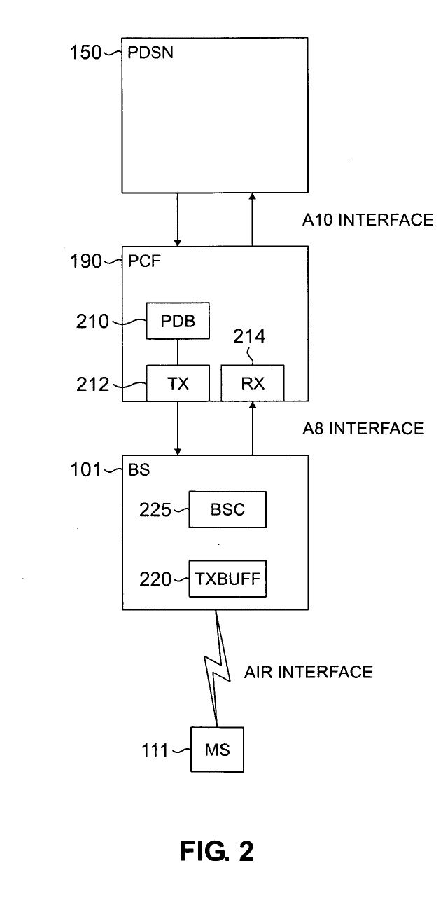

In one embodiment of the present disclosure, each of BS 101, BS 102 and BS 103 comprises a base station controller (BSC) 225, as illustrated in FIG. 2, and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of a preferred embodiment of present disclosure, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data serving node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present disclosure, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

In CDMA2000 wireless networks, the base station (BS) typically contains a transmission buffer (TXBUFF), where data packets being transmitted in the forward channel are stored prior to transmission. The transmission buffer may be associated with the Radio Link Protocol (RLP). The amount of data being held in the transmission buffer varies, depending on the conditions of the radio link to the mobile station. Lost packets may be desirably re-transmitted.

A CDMA wireless network also typically contains a packet data buffer (PDB), which may be located in packet control function (PCF) unit 190, or in packet data server node (PDSN) 150, or elsewhere in the packet data network. The packet data buffer receives packet data from wireless network 100 (typically through PDSN 150) and buffers the packet data until it can be sent to the base station for transmission over the air. Base stations 101-103, PCF unit 190, and PDSN 150 are connected via an Internet Protocol (IP) network. The interface between the base stations 101-103 and PCF unit 190 is typically referred to as the “A8 Interface” and the interface between PCF unit 190 and PDSN 150 is typically referred to as the “A10 interface”. These interfaces utilize the Generic Route Encapsulation (GRE) Protocol defined in IETF RFC 1701, known to those of skill in the art and incorporated herein by reference.

FIG. 2 illustrates selected portions of wireless network 100 in greater detail according to an exemplary embodiment of the present disclosure. In FIG. 2, PCF unit 190 comprises, among other conventional components, packet data buffer (PDB) 210, transmission component 212, and receiver component 214, all of which can be implemented using conventional hardware, with appropriate control modifications as described herein. Base station (BS) 101 comprises BSC 225 and transmission buffer (TXBUFF) 220. Other portions of PCF unit 190 and BS 101, known to those of skill in the art, are omitted here for clarity.

Forward channel data packets (i.e., data packets being transmitted to MS 111) are sent from PDSN 150 across the A10 interface to PDB 210 in PCF unit 190. Flow control messages are exchanged between PCF unit 190 and PDSN 150 across the A10 interface. Forward channel data packets are sent from PDB 210 by transmission component 212 across the A8 interface to TXBUFF 220 in BS 101. Flow control messages are exchanged between BS 101 and PCF unit 190 the A8 interface, where messages from BS 101 are received by PCF unit 190 using receiver component 214. In different embodiments, the receiver component 214 is configured to receive a data frame including a Generic Route Encapsulation protocol header from BS 101, wherein the Generic Route Encapsulation protocol header comprises a buffer level field indicating the level of data packets in TXBUFF 220. Similarly, in some embodiments, the transmission component 212 is configured to send a regulated flow of data packets from PDB 210 of PCF unit 190 to BS 101 based on the level of data packets indicated in the buffer level field of the GRE protocol header.

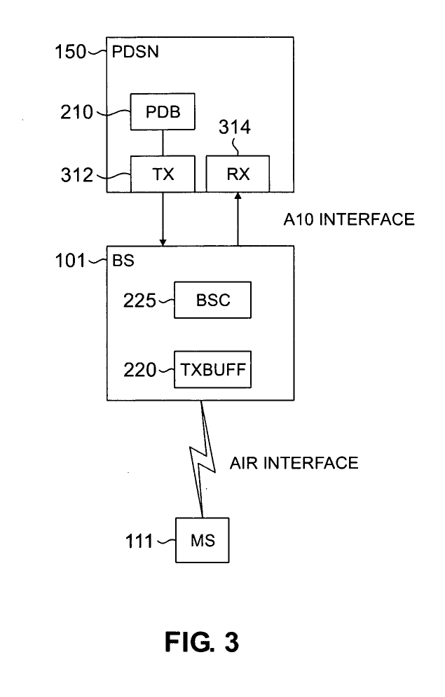

FIG. 3 illustrates selected portions of wireless network 100 in greater detail according to an alternate embodiment of the present disclosure. In FIG. 3, PDSN 150 comprises, among other conventional components, packet data buffer (PDB) 210, transmission component 312, and receiver component 314, all of which can be implemented using conventional hardware, with appropriate control modifications as described herein. Base station (BS) 101 comprises BSC 225 and transmission buffer (TXBUFF) 220. Other portions of PDSN 150 and BS 101, known to those of skill in the art, are omitted here for clarity.

Forward channel data packets are sent from PDB 210 in PDSN 150 by transmission component 212 across the A10 interface to TXBUFF 220 in BS 101. Flow control messages are exchanged between PDSN 150 and BS 101 across the A10 interface where messages from BS 101 are received by PDSN 150 using receiver component 314.

Typically, as data arrives at packet data buffer (PDB) 210, it is routed to TXBUFF 220 using the GRE protocol. BS 101 also sends data frames in the reverse direction, if data is being received from MS 111. Enhancements to the GRE protocol enable a preferred embodiment of the present disclosure to include attribute information in the GRE protocol header fields, as described below.

In different embodiments, the receiver component 314 is configured to receive a data frame including a Generic Route Encapsulation protocol header from BS 101, wherein the Generic Route Encapsulation protocol header comprises a buffer level field indicating the level of data packets in TXBUFF 220. Similarly, in some embodiments, the transmission component 312 is configured to send a regulated flow of data packets from PDB 210 of PDSN 150 to BS 101 based on the level of data packets indicated in the buffer level field of the GRE protocol header.

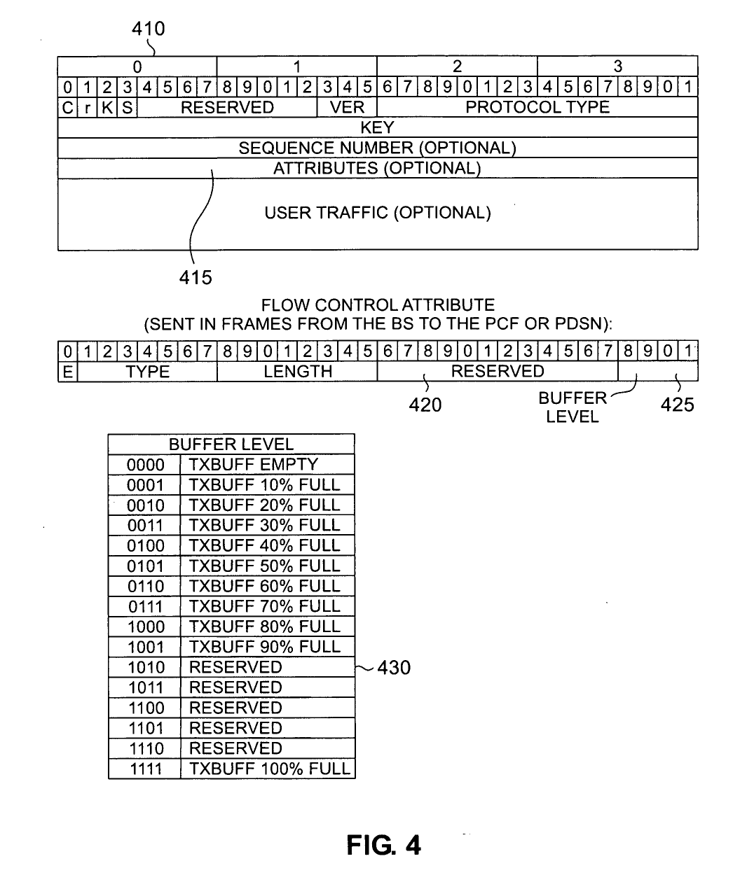

FIG. 4 illustrates Generic Route Encapsulation (GRE) protocol header 410 according to an exemplary embodiment of the present disclosure. Header 410 includes attributes field 415 that may include one or more specific attributes, for example a flow control attribute 420. The flow control attribute 420 includes a buffer level field 425. The buffer level field 425 is depicted as comprising 4-bits, but in other embodiments the buffer level field 425 may comprise a different number of bits.

A preferred embodiment of the present disclosure uses buffer level field 425 to indicate the current capacity of TXBUFF 220 to receive additional data packets. Alternatively, the buffer level field 425 may be used to indicate the currently consumed capacity of TXBUFF 220. The buffer level field 425 is assigned a value based on the level of the TXBUFF 220, and the base station 101 sends the GRE frame containing the buffer level field 425 to PCF unit 190 (or PDSN 150). The PCF 190 or PDSN 150 store data packets in PDB 210 until the TXBUFF 220 has sufficient capacity for more of the data packets stored in the PDB 210 to be sent. The level of the TXBUFF 220 and its capacity to receive more data packets is contained in GRE protocol header 410, for example in the buffer level field 425, which may be included along with any data frames BS 101 sends to PCF unit 190 or PDSN 150. If BS 101 does not have information to send, also known as user traffic, BS 101 can still send empty GRE frames, i.e., GRE frames without a data payload that contain only GRE protocol header 410.

Exemplary values for the buffer level field 425 are shown in value map 430, indicating how full the TXBUFF is in increments of 10%. Of course, those of skill in the art will recognize that other suitable increments or amounts can be used, within the scope of the disclosure. In another embodiment, for example the state of the TXBUFF being less than a specific threshold full may be represented by a single value, for example the bit value 0000 may indicate that the TXBUFF is less than 50% full or some other appropriate threshold.

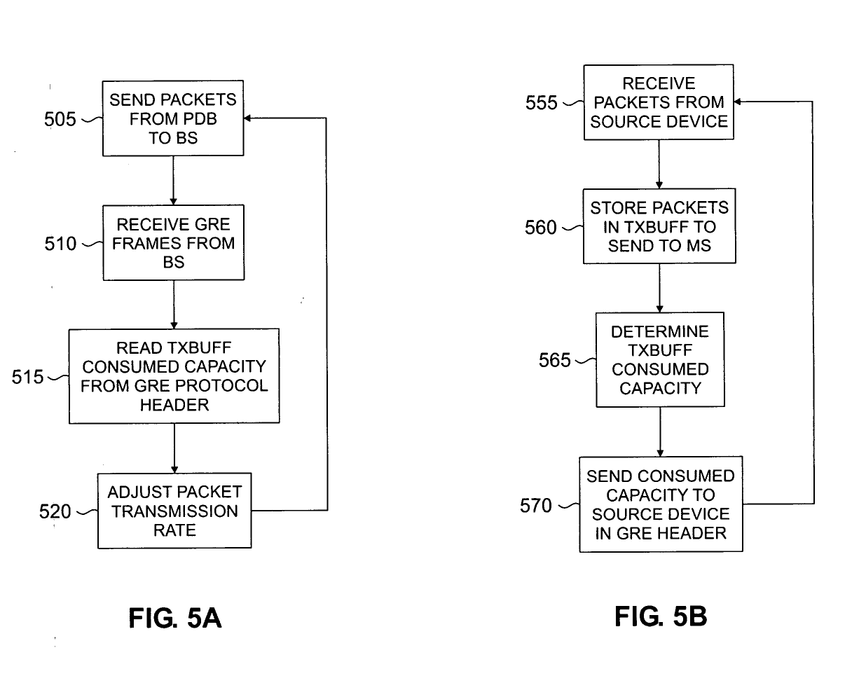

FIGS. 5A and 5B depict flowcharts of processes performed by a source device and a base station, respectively, where the source device can be a PDSN 150, a PCF unit 190, or other similar packet-sending device as known to those of skill in the art. These processes enable buffer fill management using GRE header flow control according to the principles of the present disclosure. One of the problems with the prior art is that TXBUFF 220 may overflow if too much data arrives from the source device and the air interface conditions are bad. For example, if the air interface conditions are bad the BS 101 may transmit data packets to the MS 111 at a low data rate to compensate for the poor air interface conditions or may retransmit a significant number of the data packets that were not successfully received by the MS 111 due to the poor air interface conditions, thereby reducing the rate at which the BS 101 can consume the data packets stored in the TXBUFF 220.

As described above, the source device comprises a PDB 210 or similar buffer containing packets to be sent to the base station, such as BS 101, and the base station includes a TXBUFF 220 or similar buffer containing packets received from the source device that are queued to be sent to another device, e.g., a mobile station 111, as well as a BSC 225.

As depicted in FIG. 5A, the source device sends packets from the PDB 210 to the base station (step 505). As it is doing so, the source device also receives GRE frames from the base station (step 510). As described above, these frames will include GRE header data, and at least some of the frames will include the buffer level field as a part of the header data, but a GRE frame may or may not also include a data payload.

The source device will read the TXBUFF 200 consumed capacity from the GRE frame header (step 515), which is preferably encoded as described and illustrated above with relation to FIG. 4. The source device will then regulate the flow of the packets to the base station 101 by adjusting the transmission rate at which packets are sent to the base station 101, according to the consumed capacity (step 520), and will continue sending the packets to the base station 101 (returning to step 505). In this way, the packet transmission rate can be adjusted on a real-time basis according to the feedback received from the base station indicating the consumed capacity of TXBUFF 220.

FIG. 5B illustrates a complementary process performed by base station 101. The base station 101 receives packets from the source device (step 555) and stores at least some of these in TXBUFF 220 to be sent to the mobile station (step 560). On either a periodic, occasional, or preferably continual basis, the base station will determine the consumed capacity of TXBUFF 220, preferably as a percentage of total capacity (step 565). The base station will then send the consumed capacity of TXBUFF 220 to the source device (step 570), preferably encoded in the buffer level field 425 of the GRE frame header data as described above. In a preferred embodiment, the BSC 225 performs these tasks, but those of skill in the art will recognize that other components, such as a dedicated controller or ASIC, can be used to implement this process.

These processes provide for tighter buffer synchronization between the two buffers, which is difficult to do using the prior art. For example, poor conditions on the air interface may slow the rate at which packets in TXBUFF 220 can be transmitted to the mobile station, so that packets from the source device are being added to TXBUFF 220 at a faster rate than they are being removed from TXBUFF 220 to be sent to the mobile station. As a result, TXBUFF 220 will be filling up, and could overflow, and the buffer level field 425 in the GRE header data sent from BS 101 to the source device will indicate that the TXBUFF 220 buffer level has risen from, for example, 70% to 80% full.

In this example, the source device would preferably respond by slowing the packet transmission rate to compensate, until the TXBUFF 220 buffer level drops gradually to a lower level, such as 20% full. Finally, when the buffer level field 425 indicates that the TXBUFF 220 level has reduced, the source device will increase the packet transmission rate until it reaches a stable consumed capacity level. In this way, the flow of data packets is preferably reduced when the buffer level field 425 indicates that the transmission buffer is substantially full, and the flow of data packets is preferably increased when the buffer level field 425 indicates that the transmission buffer is not substantially full.

Of course, the transmission rate of the source device can also vary according to other factors known to those of skill in the art, including the amount of packets in the PDB 210 to be sent to the mobile station 111. In preferred embodiments, an XON/XOFF protocol is not used for flow control between the source device and the base station.

A preferred embodiment allows for a more efficient and accurate flow control mechanism between TXBUFF 220 and PDB 210. Since GRE frames may be continuously sent from BS 101 to PCF unit 190 or PDSN 150, the PCF unit 190 or PDSN 150 will continuously receive information about the consumed capacity of TXBUFF 220. A preferred embodiment piggybacks this information on data packets that normally are sent from BS 101 to PCF unit 190 or PDSN 150, so extra signaling is not needed. Also, by using the buffer level field 425 in GRE protocol header 410, the PCF unit 190 or PDSN 150 can better decide how much data to transfer from the PDB 210 to the TXBUFF 220, as opposed to the simple ON/OFF signaling used in the prior art.

In some embodiments, the PCF unit 190 or PDSN 150 actively adjusts the rate at which data is transferred from the PDB 210 to TXBUFF 220 according the current available or consumed capacity of TXBUFF 220. For example, if TXBUFF 220 is 80% full, or if the available capacity to the TXBUFF 220 is rapidly decreasing, then the PCF unit 190 or PDSN 150 can slow the rate data is transferred from the PDB 210 to the TXBUFF 220 until the rate of change of the capacity of TXBUFF 220 levels off or the available capacity of TXBUFF 220 increases. In this way, data can be transferred at a dynamic rate to avoid overloading TXBUFF 220 or to ensure there is always spare capacity available if suddenly needed.

In other embodiments, traffic can be prioritized, using known methods, and the techniques described herein can be used to ensure that there is always sufficient available capacity in TXBUFF 220 for high-priority data traffic. In some embodiments, the base station does not continually send consumed capacity data, but only sends consumed capacity data when the consumed capacity of TXBUFF rises above or falls below a predetermined threshold.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of packet data flow control, comprising:
receiving a data frame including a Generic Route Encapsulation protocol header from a base station, wherein the Generic Route Encapsulation protocol header comprises a buffer level field indicating the level of data packets in a transmission buffer of the base station; and
regulating the flow of data packets from a packet data buffer in a source device to the transmission buffer based on the level of data packets indicated in the buffer level field.

2. The method of claim 1, wherein the flow of data packets is reduced when the buffer level field indicates that the transmission buffer is substantially full.

3. The method of claim 1, wherein the flow of data packets is increased when the buffer level field indicates that the transmission buffer is not substantially full.

4. The method of claim 1, wherein the buffer level field is a four-bit field.

5. The method of claim 1, wherein an XON/XOFF protocol is not used by the source device to regulate the flow of data packets.

6. The method of claim 1, wherein the data frame does not include a data payload.

7. The method of claim 1, wherein the base station supports a CDMA 2000 wireless network.

8. A source device, comprising:
a packet data buffer;
a receiver component configured to receive a data frame including a Generic Route Encapsulation protocol header from a base station, wherein the Generic Route Encapsulation protocol header comprises a buffer level field indicating the level of data packets in a transmission buffer of the base station; and
a transmission component configured to send a regulated flow of data packets from the packet data buffer to the base station based on the level of data packets indicated in the buffer level field.

9. The source device of claim 8, wherein the flow of data packets is reduced when the buffer level field indicates that the transmission buffer is substantially full.

10. The source device of claim 8, wherein the flow of data packets is increased when the buffer level field indicates that the transmission buffer is not substantially full.

11. The source device of claim 8, wherein the buffer level field is a four-bit field.

12. The source device of claim 8, wherein an XON/XOFF protocol is not used by the source device to regulate the flow of data packets.

13. The source device of claim 8, wherein the source device is selected from the group consisting of a packet data serving node and a packet control function unit.

14. The source device of claim 8, wherein the data frame does not include a data payload.

15. A base station, comprising:
a transmission buffer containing packet data;
a controller configured to transmit a data frame including a Generic Route Encapsulation protocol header to a source device, wherein the Generic Route Encapsulation protocol header comprises a buffer level field indicating a level of data packets in the transmission buffer.

16. The base station of claim 15, wherein the base station is configured to receive packet data from the source device to be stored in the transmission buffer.

17. The base station of claim 15, the base station is configured to transmit packet data from the transmission buffer to a mobile station.

18. The base station of claim 15, wherein the buffer level field is a four-bit field.

19. The base station of claim 15, wherein the source device is selected from the group consisting of a packet data serving node and a packet control function unit.

20. The base station of claim 15, wherein the data frame does not include a data payload.
